(19) United States
(12) Patent Application Publication
(10) Pub. No.: US 2023/0373333 A1
(43) Pub. Date: Nov. 23, 2023

(54) CHARGING PORT ALIGNMENT METHODS AND APPARATUS FOR ROBOTIC CAR CHARGERS

(71) Applicant: Procom Engineering, Inc., Aliso Viejo, CA (US)

(72) Inventors: Wesley Zhou, Aliso Viejo, CA (US); Shepherd Darquea, Carson City, NV (US); Morgan Simpson, Carson City, NV (US)

(73) Assignee: Procom Engineering, Inc., Aliso Viejo, CA (US)

(21) Appl. No.: 17/748,672

(22) Filed: May 19, 2022

(51) Int. Cl. B60L 53/37; B60L 53/16; B25J 9/16; B25J 15/00

(52) U.S. Cl. CPC B60L 53/37; B60L 53/16; B25J 9/1697; B25J 15/0019

(57) ABSTRACT

A camera is located within an array of receptacles of a robotically controlled vehicle charging connector which receptacles are configured to mate and establish electrical connection with respective mating pins of a vehicle's charging port. Image signals generated by the camera are supplied to a computer vision processor which generates motor control signals which enable the connector receptacles and mating pins to be properly aligned so as to enable the charging connector to be robotically plugged into the vehicle's charging port. In other embodiments, the mating pins may be located in the charging connector and the receptacles in the charging port.

### FIELD OF THE DISCLOSURE

The subject disclosure relates to methods and apparatus for robotically charging electric vehicles and more particularly to apparatus which facilitates the establishment of electrical connection between a robot charging connector and a charging socket of an electrically powered vehicle by employing computer vision to align a charging connector with the vehicle's charging port. Electric vehicles may include, inter alia, vehicles which are powered in whole or in part by one or more electric motors or other electric powered means.

### DESCRIPTION OF RELATED ART

Robotic vehicle charging apparatus has been disclosed in the past, for example, as illustrated in U.S. Pat. No. 9,056,555 entitled “Vehicle Charge Robot,” the contents of which is incorporated by this reference herein in its entirety.

### SUMMARY

According to illustrative embodiments, electrical vehicle charging apparatus is provided comprising an electrical connector including an array of receptacles configured to receive and establish electrical connection with respective mating pins of a vehicle's charging port. A camera is located within the array of receptacles, the camera defining an X-Y plane, the camera being positioned to generate an electronic image of the vehicle's charging port and features within the charging port such as mating electrical connection pins. In an alternate embodiment, the connector may include an array of pins and the charging port may include an array of mating receptacles and a camera located within the array.

In one illustrative embodiment, the image signals generated by the camera are supplied to apparatus comprising one or more processors and memory storing executable instructions, which, when executed by the one or more processors, establish a bounding box around each of a plurality or at least one of the pins, calculate an X distance by which the pin is displaced horizontally from a center of its respective bounding box, calculate a Y distance by which the pin is displaced vertically from the center of its respective bounding box, and generate X and Y axis motor control signals to cause one or more motors to adjust the position of the connector so as to move the respective pins towards the center of the bounding box. In one illustrative embodiment, each bounding box is square. In one illustrative embodiment, a larger bounding box is established which surrounds all of the mating pins.

Another illustrative embodiment provides a method comprising locating a camera within an array of receptacles of a vehicle charging connector, the array of receptacles being configured to receive and establish electrical connection with respective mating pins of a vehicle's charging port such that the camera defines an X-Y plane and is positioned to generate signals comprising an electronic image of the mating pins of a vehicle charging port. The method may further comprise supplying one or more processors with said signals; and employing the one or more processors to perform any one or more of the following operations:
(a) establish a bounding box around each of a plurality or at least one of said pins;
(b) calculate an X distance by which the pin is displaced horizontally from a center of its respective bounding box;
(c) calculate a Y distance by which the pin is displaced vertically from the center of its respective bounding box: and
(d) generate X and Y axis motor control signals which enable a plurality of motors to adjust the position of said connector such that the respective pins of the vehicle are aligned to mate with the receptacles of the connector.

Other illustrative embodiments comprise a method comprising: locating a camera within an array of receptacles of a vehicle charging connector, the array of receptacles being configured to receive and establish electrical connection with a vehicle's charging port such that the camera defines an X-Y plane and is positioned to generate an electronic image of the vehicle charging port; supplying one or more processors with said electronic image; employing the one or more processors to establish a plurality of boundary boxes which locate and identify the charging port and a plurality interconnection ports located within the charging port; and calculating an offset distance selected to correct for misalignment of said charging connector with respect to said charging port. Such a method may or may not include generating one or more motor controls signals which enable one or more motors to adjust the position of the charging connector to compensate for said offset distance.

Another illustrative method may include aligning pins/receptacles of a vehicle charging port to mate with receptacle/pins of a robot charging plug comprising positioning a camera to view the vehicle charging port and to generate an image of the charging port; employing computer vision software to use the image to determine an offset between one of the pins and one of the receptacles and to generate one or more motor control signals. Such embodiments may or may not further comprise employing the one or more motor control signals to correct the offset.

### DESCRIPTION OF THE DRAWINGS

FIG. 1 is a perspective view of a vehicle charging robot according to an illustrative embodiment;

FIG. 2 is a circuit block diagram of control of control circuitry employed in an illustrative embodiment;

FIG. 3 is a flowchart illustrating steps performed by the computer vision software of the illustrative embodiment;

FIG. 4 is a continuation of the flowchart of FIG. 3;

FIG. 5 is a flowchart illustrating further steps performed by the computer vision software;

FIG. 6 is a flowchart illustrating further steps performed by the computer vision software;

FIG. 7 is a perspective view of an illustrative vehicle charging robot;

FIG. 8 is a second perspective view of the illustrative robot;

FIG. 9 is a perspective view illustrating the robot's latching mechanism and camera in an extended position;

FIG. 10 is a perspective view illustrating the robot's latching mechanism and camera in a retracted position;

FIG. 11 is a perspective view illustrating a portion of the motor drive componentry employed in the illustrative robot;

FIG. 12 is a perspective view illustrating a portion of the differential drive gear componentry employed in the illustrative robot;

FIG. 13 is a perspective view of a differential gear system according to an illustrative embodiment;

FIG. 14 is a perspective view illustrating a linear drive apparatus for extending and retracting a latch and camera assembly according to an illustrative embodiment.

FIG. 15 is a front perspective view of a vehicle charging port seen by a camera positioned above the vehicle charging port;

FIG. 16 is a front view of the charging port of FIG. 15 as seen by a camera pointed straight at the port,

FIG. 17 is a schematic diagram illustrative of operation of an illustrative embodiment; and

FIG. 18 is a schematic diagram illustrative of operation of an alternate embodiments.

### DETAILED DESCRIPTION

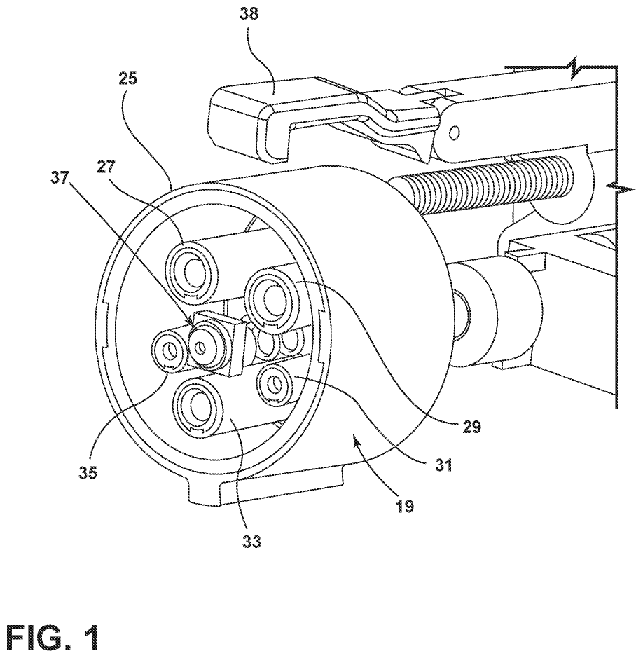

A vehicle charging connector or “plug” 19 is illustrated in more detail in FIG. 1. In illustrative embodiments, the connector 19 may be an SAE 1772 or other connector, which is configured to plug into a corresponding socket of a vehicle. As shown, in one embodiment, the connector 19 includes a latch 38 and an outer cylinder 25, within which are positioned five linearly projecting cylindrical female pin receptacles or “charging port holes” 27, 29, 31, 33, 35, which are configured to receive and establish electrical connection with respective mating pins of the vehicle's charging port. Different pin and plug arrangements may be used in various embodiments.

In the illustrative embodiment, a computer vision camera 37 is centrally positioned within the outer cylinder 25. An example of such a camera 37 is a miniature infrared camera such as a REDEAGLE CCTV 1000TVL Mini Home Security Video Surveillance Camera employing 6 IR (infrared) LEDs and a centrally located lens. In the illustrative embodiment, the camera 37 retracts once the connector 19 is properly aligned with the vehicle charging port in order to prevent the port from blocking the camera's view and to enable successful plug-in by avoiding potential collision between the port and camera.

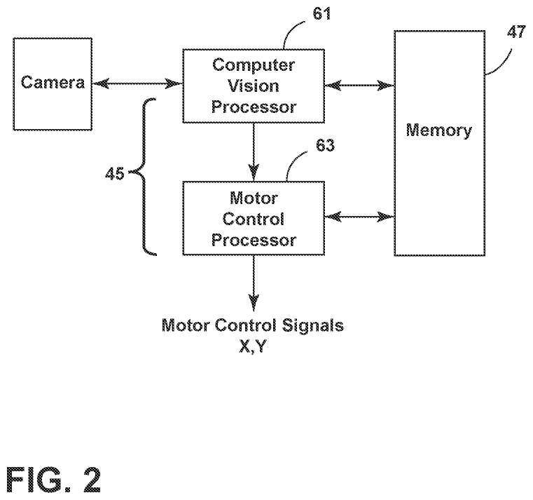

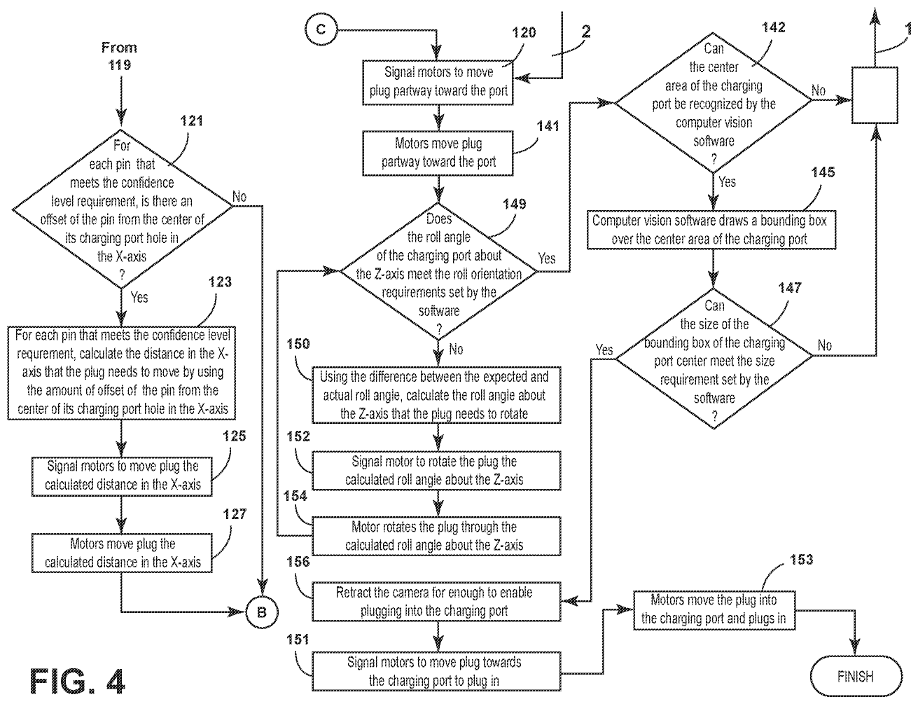

In one illustrative embodiment, a controller 45 shown in FIG. 2 is employed to control the position of the connector 19 and camera 37. In an illustrative embodiment, the controller 45 may comprise a microprocessor based system or other computing device capable of executing programmed instructions to process input signals such as the input from the camera 37 and provide output control signals as required to control the position of the connector 19 with respect to the charging socket of the vehicle. In one embodiment, the controller 45 is configured to receive camera input signals and to provide output control signals e.g. X, Y, in order to the drive the connector positioning electric motors of a robot. In one embodiment, the controller 45 includes non-transitory executable instructions stored in a non-transitory computer readable medium or memory 47. The executable instructions serve, inter alia, to cause generation of suitable control signals to cause the connector 19 to perform the movements and functions described herein in more detail below in connection with FIGS. 4-7.

In illustrative embodiments, communication of the camera image to the computer vision processor 61 and from the processor 61 to the motor control processor 63 may be achieved using industry standard signal protocols. For example, in an illustrative embodiment, camera to processor communication can employ the industry standard MIPI CSI-2 protocol, or USB, while the processor 61 can communicate with the motor controller 63 using a standard SPI protocol.

In one illustrative embodiment shown in FIG. 2, the robot control circuitry comprises two circuit boards, one being a computer vision circuit board 61 and the other being a circuit board 63 comprising, for example, a microprocessor or microcontroller which controls the robot motors and other hardware. In one embodiment, the computer vision circuit board 61 may be a Nvidia Jetson Nano comprising a Quad-core ARM® Cortex®-A57 MPCore processor and a 4 GB 64-bit LPDDR4 memory. The Jetson Nano employs an installed operating system, which may be, for example, Ubuntu, a version of Linux, and can be programmed to provide the artificial intelligence and computer vision functions hereinafter described. See https://www.nvidia.com/en-us/autonomous-machines/embedded-systems/jetson-nano/. Other off-the-shelf or custom circuitry providing such functions may alternatively be employed.

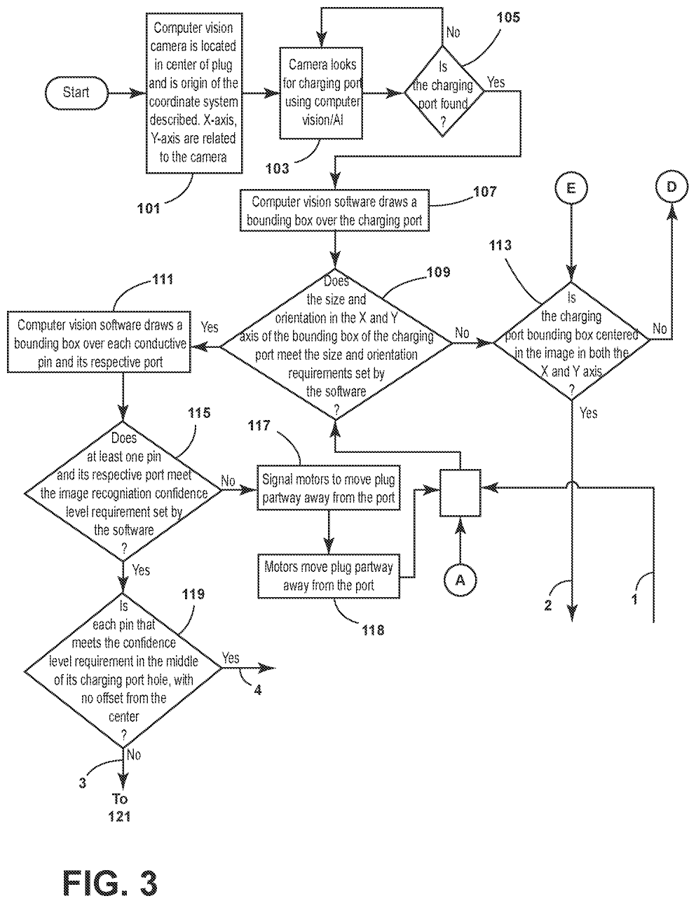

According to the illustrative embodiment, the computer vision camera 37 is located in the center of the connector 19 and is the origin of an X axis, Y axis coordinate system as referenced in block 101 of FIG. 3. In step 103, the camera 37 looks for the vehicle charging port using computer vision/AI. At step 105, a test is performed to determine whether the charging port has been found. If it has not, the flow returns to step 103 and when the car charging port is found, the flow proceeds to step 107 where the software draws a bounding box around the charging port.

In an illustrative embodiment, the computer vision software is “trained” on recognizing the charging port and associated components by using labeled data sets of objects using, for example, known machine learning methods to learn from hundreds or thousands of images of charging ports so that the software can recognize that the electronic image which the camera 37 is transmitting is a charging port.

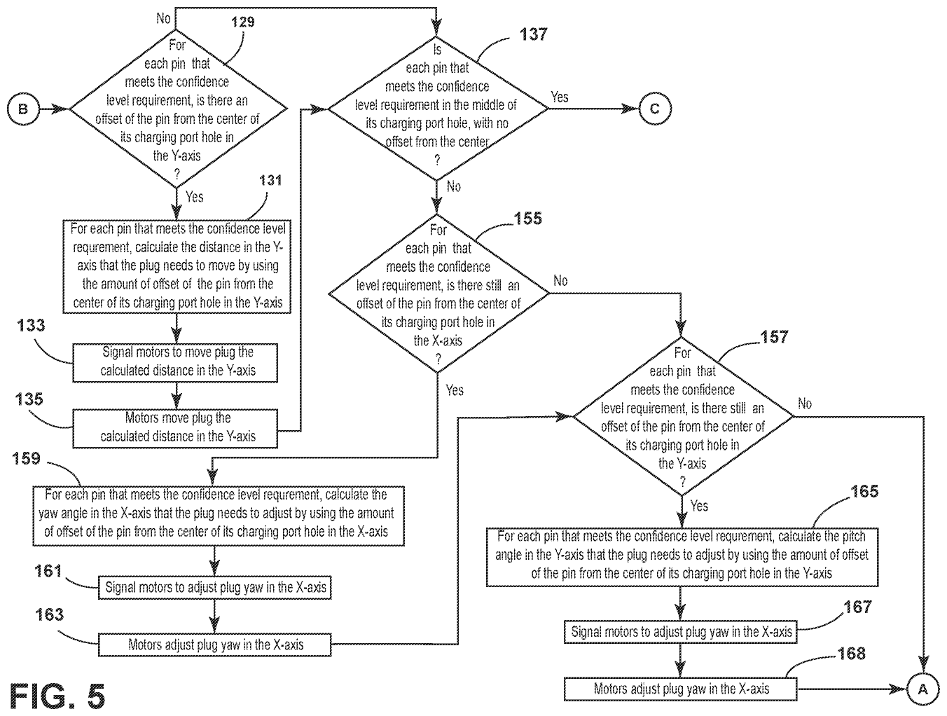

Once the bounding box has been drawn, the flow proceeds to test 109 where the software determines whether the size and orientation in the X and Y axes of the bounding box of the charging port meet pre-programmed size and orientation requirements in the software. If so, in step 111, the computer vision software draws a bounding box over each of the five conductive pins of the vehicle charging port and over its respective port in step 111. If not, the flow proceeds to test 113 where the software determines whether the charging port bounding box is centered on the charging port image in both the X and Y axes and if it is not, the flow proceeds to entry point D of FIG. 5.

Assuming step 111 is performed, the flow proceeds to test 115 where it is determined whether at least one pin and its respective port meet the image recognition confidence level requirement programmed into the software. If not, steps 117 and 118 are performed where the motors are signaled to move the plug 19 away from the vehicle port whereafter the flow returns to test 109.

If test 115 is satisfied, the flow proceeds to test 119 where it is determined whether each pin of the vehicle charging port or each of a subset of the pins that meet the confidence level requirement is located in the middle of its respective charging port hole 27, 29, 31, 33, 35, with no offset from the center within a confidence level requirement set in the software. If not, the flow proceeds to determine X and Y axis adjustments required to center each pin or the subset of pins.

In particular, steps 121, 123, 125, and 127 are performed wherein, for each pin that meets the confidence level requirement, the software calculates the distance in the X-axis that the plug 19 needs to move by using the amount of offset of the pin from the center of its charging port hole in the X-axis and signals the motors to move the plug the calculated distance in the X axis in response to which the motors move the plug the calculated distance in the X axis. Then, in step 129 (FIG. 5), the software performs tests to determine whether, for each pin that meets the confidence level requirement, there is an offset of the pin from the center of its charging port hole in the Y-axis. If so, then in steps 131, 133 and 135, for each pin that meets the confidence level requirement, the software calculates the distance in the Y-axis that the plug 19 needs to move by using the amount of offset of the pin from the center of its charging port hole in the Y-axis and signals the motors to move the plug the calculated distance in the Y-axis after which the motors move plug 19 the calculated distance.

Once these X and Y adjustments have been made, a test 137 (FIG. 5) is performed to determine whether each charging pin is centered in its charging port hole. If it is, the flow proceeds to entry point C (FIG. 4) where steps and tests are performed to ultimately cause the motors to plug the connector 19 into the vehicle charging port. In particular, in step 141, the motors move the plug 19 toward the charging port and a test 149 is performed to determine if the roll angle of the charging port about the Z axis meets the roll orientation requirements set by the software. If so, a test 142 is performed to determine whether the center of the charging port can be recognized by the computer vision software and, if so, in step 145, the computer vision software draws a bounding box over the center area of the charging port and determines in test 147 whether the size of the bounding box meets the size requirement set by the software. If so, in steps 156, 151, and 153, a motor retracts the camera far enough to enable the plug 19 to be inserted into the charging port, the motors are signaled to move plug 19 towards the charging port, and finally to plug the plug 19 into electrically connected position with the charging port.

If the roll angle does not meet requirements in test 149, steps 150, 152, and 154 are performed where the difference between the expected and actual roll angle is used to calculate the roll angle about the Z axis that the plug 19 needs to rotate in order to meet the expected roll angle, the motors are signaled to rotate the plug 19 through the calculated roll angle then rotates the plug 19 through the calculated roll angle. Test 149 is then performed again to confirm that the proper roll angle has been achieved.

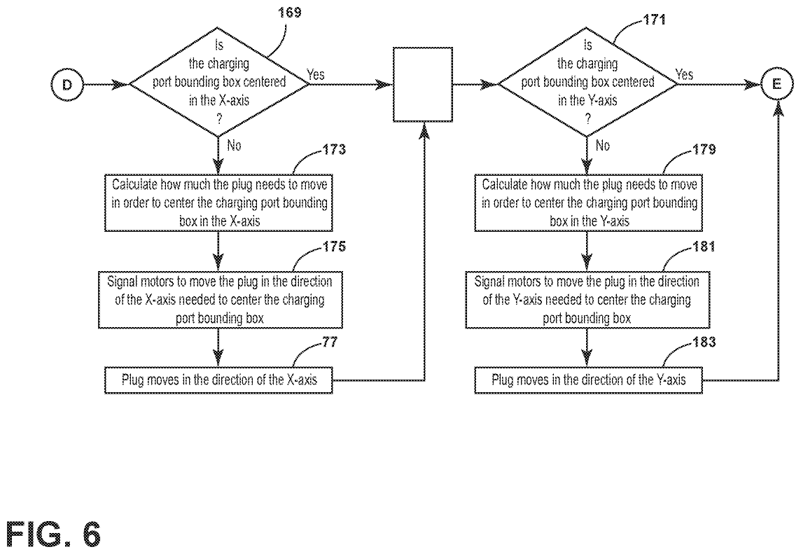

The remaining steps in the illustrative flowcharts are performed in response to various misalignment detections. For example, if test 137 of FIG. 5 is not satisfied, tests 155, 157 are performed to detect X and Y misalignment conditions and steps 165, 167, 168 are performed to calculate and correct the misalignment. Similarly, if test 113 of FIG. 3 is not satisfied, the flow proceeds to entry point D of FIG. 6 to perform tests 169, 171 and steps 173, 175, 177 and 179, 181, 183 to calculate and correct for any X and Y misalignment of the charging port bounding box.

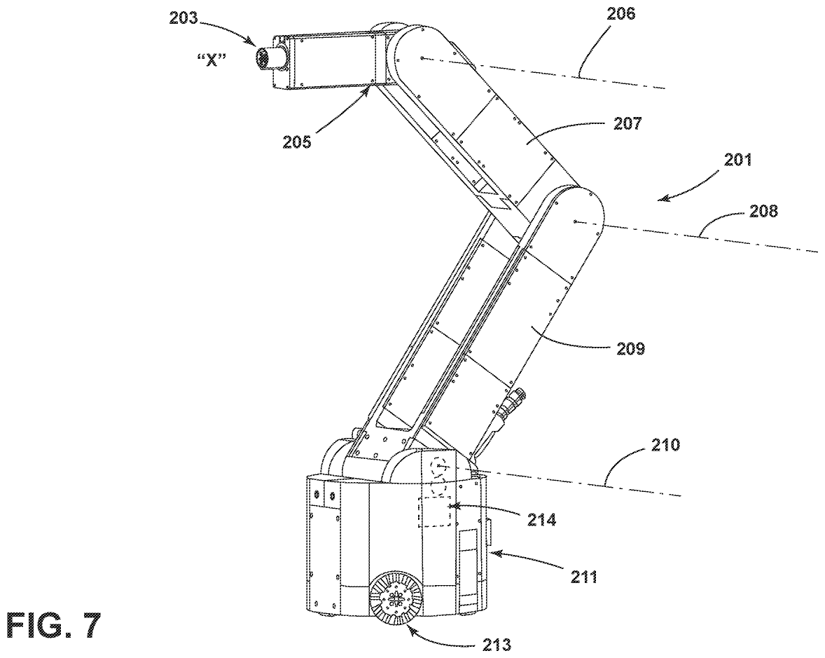

FIGS. 7-13 show an illustrative robot 201 with illustrative drive mechanisms for positioning the connector 19 as described in the flow charts of FIGS. 3-6. According to FIG. 7, the illustrative robot 201 includes a camera and latch system 203, robot arms 207, 209, and a robot base 211 having motor driven wheels 213. FIG. 7 further illustrates a joint 205 for Z axis roll and joints for enabling pivotal motion about first, second and third axes 206, 208, 110.

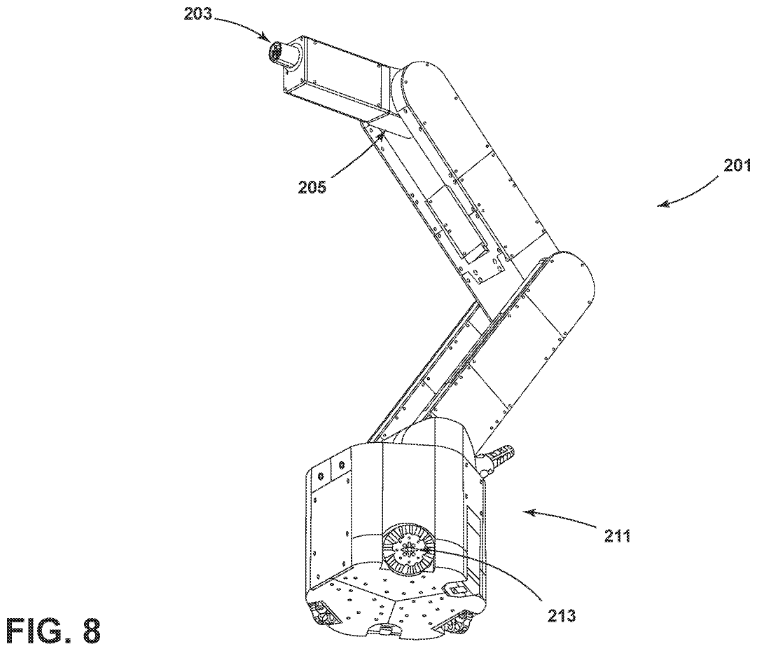

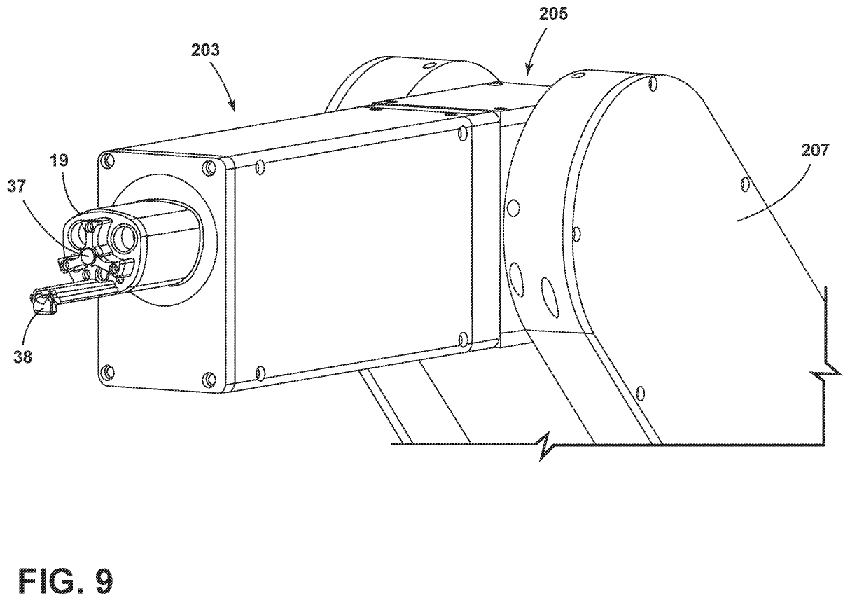

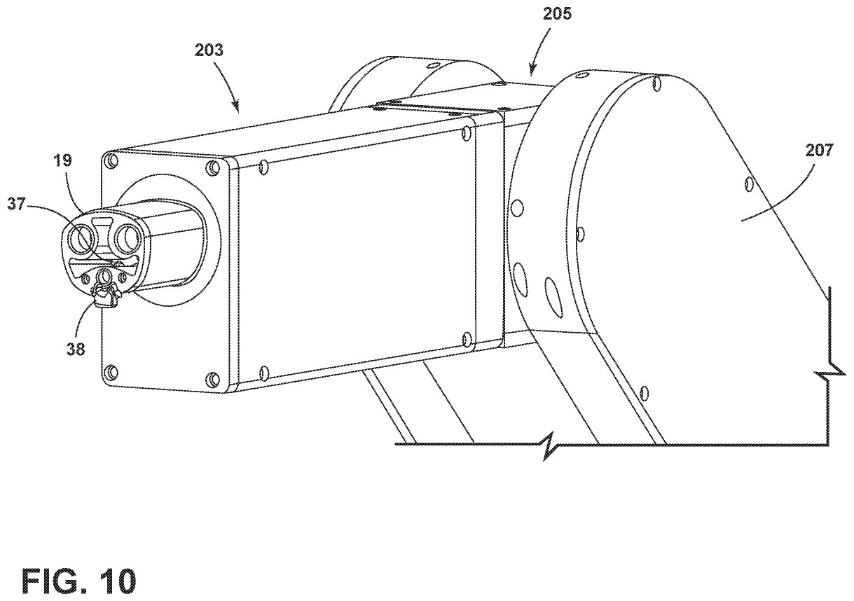

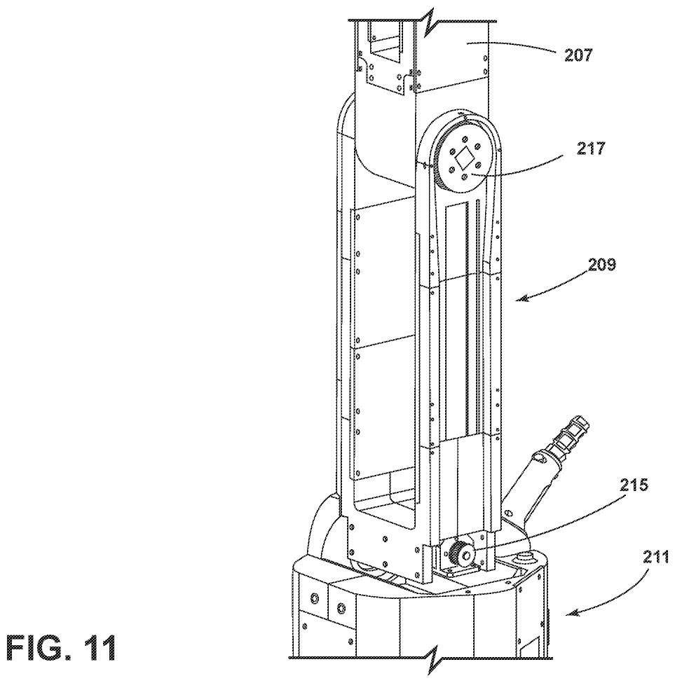

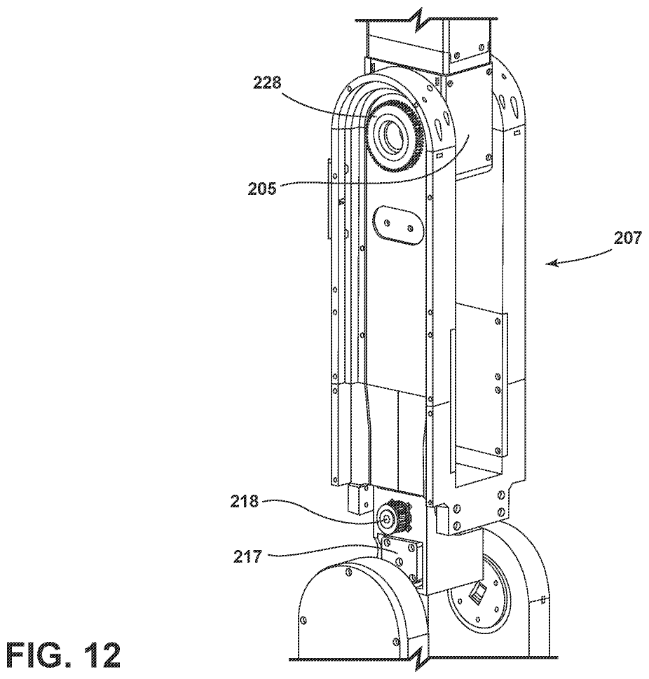

FIG. 8 shows three individually motor-driven omni-wheels 213 for moving the robot plug in the X axis, adjusting yaw in the X axis, and for moving the robot towards and away from an electric vehicle. FIGS. 9 and 10 illustrate the latching mechanism 38 in the extended and retracted position, respectively. FIG. 11 illustrates a motor drive gear 215 to power movement about axis 208 via a belt gear drive supplied to a gear 217, while FIG. 12 illustrates one of two oppositely disposed motors 218, each powering one side of a differential gear 221 via gears 228 shown in FIG. 13 via a belt drive system.

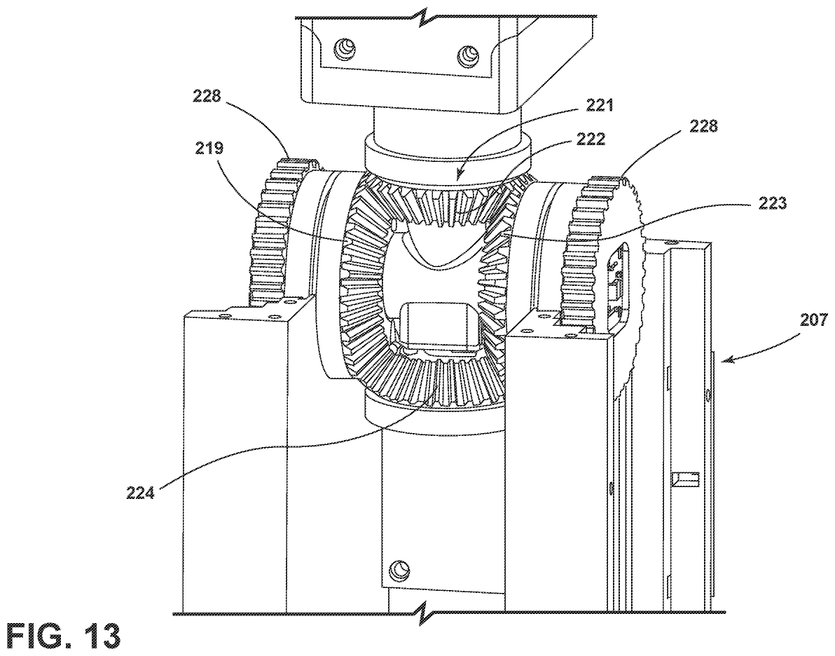

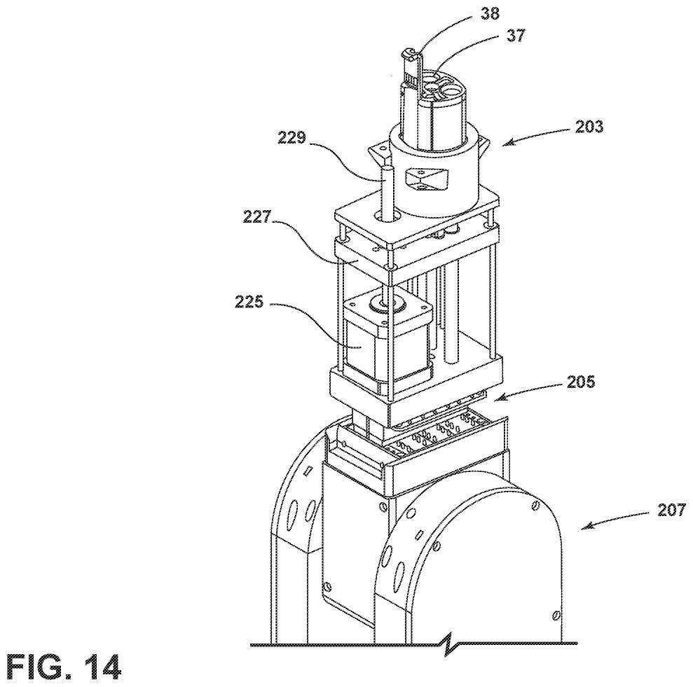

The differential gear system 221 includes a left gear 219 and a right gear 223 and upper and lower gears 222, 224. When driven together, the gears 221, 222, 223, 224 cause the third joint to adjust pitch in the Y axis. When only the left- or right-side gear 219, 223 is driven, the third joint is caused to adjust roll in the Z axis. FIG. 14 illustrates an embodiment wherein a linear drive motor 225 drives movement of a plate 227 to retract and extend the latch and camera mechanism 203.

As those skilled in the art will appreciate, assuming that “X” (FIG. 7) is the target charging port, the Y position of the connector 19 is determined by the combined angle/position of the second and third joints 208, 210 shown in FIG. 7. The manner in which the higher joint 208 is moved is shown in FIG. 11 where 215 is the motor which is connected to the joint gear 217 to control the rotational position of the joint 208. The angular or rotational position of the lower joint 210 is controlled, for example, by a motor and an associated gear and belt drive system 214 located in the lower housing 211.

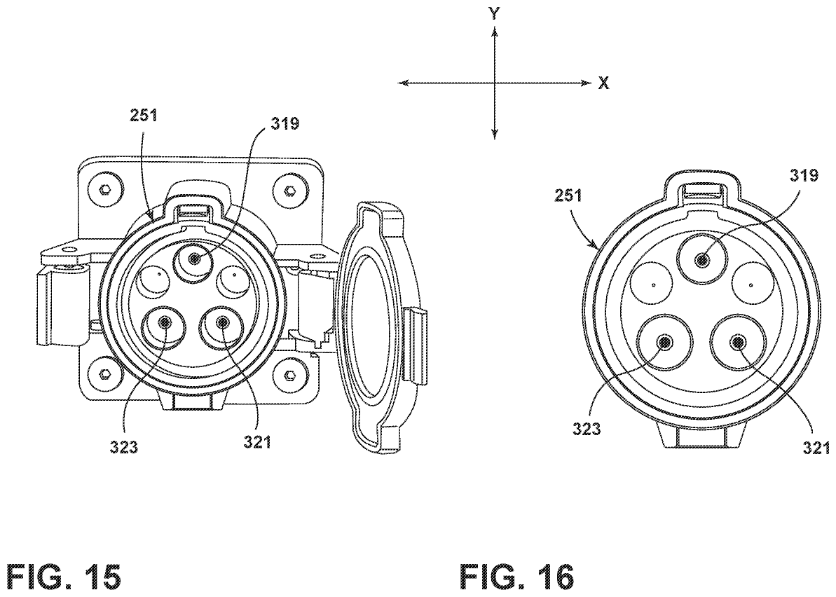

FIG. 15 shows a vehicle charging port 251 having receptacles 311. 313, 319 wherein mating pins 319, 321, 323 are respectively positioned, and in an illustrative embodiment are slightly recessed into the port circles. In the image of FIG. 15, the pins look closer to the top of each circle rather than the middle because the camera 37 is positioned above the port 251, creating the illusion of the offset. FIG. 16 shows the same port 251 where the camera 37 is pointed straight on at the port, resulting in the pins appearing to be exactly in the middle of the circles. If the camera 37 sees and transmits the image of FIG. 15, the software will know to move down in the Y axis in order to move the plug 19 closer to the desired mating position shown in FIG. 16.

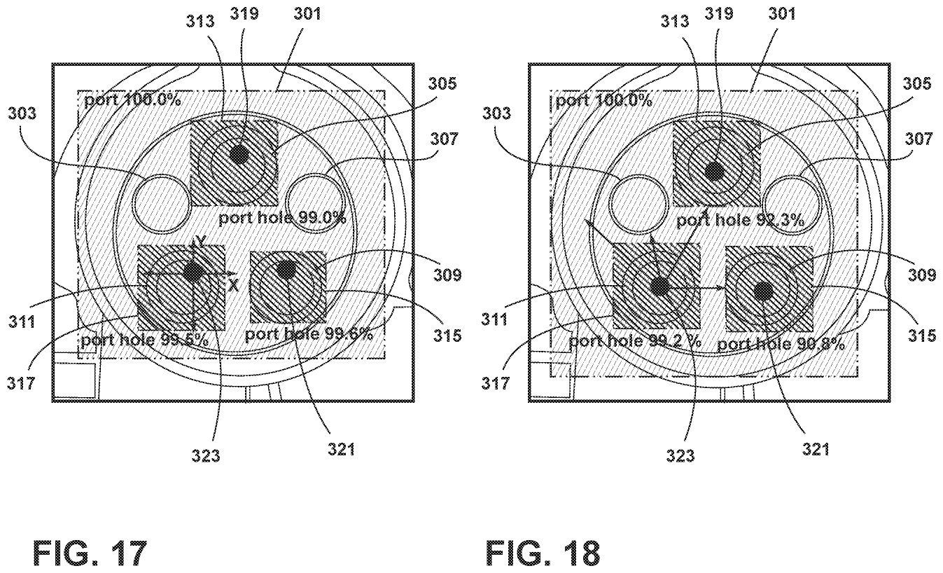

FIG. 17 is a screenshot of a display produced by the computer vision software to further illustrate its operation. In particular, FIG. 17 illustrates a large square bounding box 301 which surrounds all five of the charging port circles 303, 305, 307, 309, 311 of the vehicle's charging port. Three of these circles 305, 309, 311, so-called “main’ circles, are encompassed by a respective smaller square bounding box 313, 315, 317. Within each smaller square bounding box is a respective pin image 319, 321, 323, which represents the position of three respective conductive male pins of the charging port of an electric vehicle as detected by the computer vision camera 37.

In the example of FIG. 17, because the pin 323 is closer to the right edge of the circle 311 in the X axis, the program determines that the camera 37 (and thus the plug 19 since the camera 37 is in the middle of the plug 19) needs to move to the left in order to get closer to proper mating position. The amount of offset of the pin 323 from the center of the circle 311 is used to determine approximately how much to the left the plug 19 needs to move so that the pin 323 is centered. Similarly, for the Y axis, the pin 323 is closer to the top of the circle 311, which means that the plug 19 needs to move down. In an illustrative embodiment, the other pins 319, 321 are similarly analyzed, and the software uses an average of the three X offsets and three Y offsets to determine the actual X and Y distances the plug 19 will be moved. In FIGS. 17 and 18, the percentages shown are the live representations of how confident the software is that the object detected is what it thinks it is. For example, in the image of FIG. 17, the software is 100% confident that it is looking at a charging port, and about 99% confident that the top circle is what the software calls a “port hole.”

In other embodiments, the offset of the pin to other features of the port may be used to calculate the X and Y movement to be imparted to the plug, for example, like the other circles or the edge of the port, as shown in FIG. 18. Additionally, while the illustrative embodiment of FIG. 17 uses three pins, the smaller pins located in the other 2 smaller circles may also be used in alternate embodiments.

For the purposes of this disclosure, a computer readable medium or memory stores computer data, which data can and typically does include computer program code that is executable by a computer, in machine readable form. By way of example, and not limitation, a computer readable medium or memory may comprise computer readable storage media, for tangible or fixed storage of data, or communication media for transient interpretation of code-containing signals. Computer readable storage media or “memory,”, as used herein, refers to non-transitory physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media or memory includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desire information or data or instructions and which can be accessed by a computer or processor. In various embodiments, when suitable computer program code is loaded into and executed by a computer, the computer becomes a specially configured apparatus.

From the foregoing, those skilled in the art will appreciate that various adaptations and modifications of the just described illustrative embodiments can be configured without departing from the scope and spirit of the invention. For example, the disclosed offset alignment correction method may be employed with charging ports of other electric vehicles, for example, such as the Tesla. Therefore, it is to be understood that, within the scope of the appended claims, the invention may be practiced other than as specifically described herein.

What is claimed is:

1. An apparatus comprising:
an electrical connector for a vehicle charging apparatus comprising an array of receptacles configured to receive and establish electrical connection with respective mating pins of a vehicle's charging port;
a camera located within the array of receptacles, the camera defining an X-Y plane, the camera being positioned to generate an electronic image of said vehicle charging port and mating pins;
one or more processors, at least one processor being supplied with said electronic image;
a non-transitory computer readable medium or a plurality of non-transitory computer readable media storing executable instructions, which when executed by the one or more processors, cause performance of the following operations:
establish a charging port bounding box around said vehicle charging port;
establish a pin bounding box around each of a plurality of said pins;
calculate an X offset distance calculated to center a first pin horizontally in its respective pin bounding box;
calculate a Y offset distance calculated to center the first pin vertically in its respective pin bounding box: and
generate a plurality of motor control signals which, when supplied to one or more motors, are sufficient to enable said one or motors to adjust the position of said connector so as to reduce said X offset distance and said Y offset distance.

2. The apparatus of claim 1 wherein each pin bounding box is square.

3. The apparatus of claim 1 wherein said charging port bounding box is square.

4. The apparatus of claim 2 wherein said charging port bounding box is square.

5. The apparatus of claim 1 wherein said electrical connector is positioned at least in part by a plurality of motors configured to pivot first and second robot arms about first, second, and third parallel axes.

6. The apparatus of claim 5 further comprising a differential gear system having a left gear and a right gear configured such that when driven together, the gears of the system cause a third joint to adjust pitch in the Y axis and such that when only the left- or right-side gear is driven, the third joint is caused to adjust roll in the Z axis.

7. The apparatus of claim 1 wherein three motor-driven wheels are configured to move the electrical connector in the X axis.

8. The apparatus of claim 7 wherein the three motor driven wheels are further configured to move a robot carrying the electrical connector towards and away from the vehicle's electrical charging port.

9. The apparatus of claim 1 further configured to retract the camera once the connector is properly aligned with the charging port.

10. A method comprising:
locating a camera within an array of receptacles of a vehicle charging connector, the array of receptacles being configured to receive and establish electrical connection with a vehicle's charging port such that the camera defines an X-Y plane and is positioned to generate an electronic image of the vehicle charging port;
supplying one or more processors with said electronic image;
employing said one or more processors to establish a plurality of boundary boxes which locate and identify said charging port and a plurality interconnection ports located within said charging port; and
calculating an offset distance selected to correct for misalignment of said charging connector with respect to said charging port.

11. The method of claim 10 further comprising generating one or more motor controls signals which enable one or more motors to adjust the position of said connector to compensate for said offset distance.

12. The method of claim 10 further comprising retracting the camera once the charging connector is properly aligned with the vehicle's charging port.

13. An apparatus comprising:
an electrical connector for a vehicle charging apparatus comprising an array of pins configured to mate and establish electrical connection with respective mating receptacles of a vehicle's charging port;
a camera located within the array of receptacles, the camera defining an X-Y plane, the camera being positioned to generate signals comprising an electronic image of said mating pins;
one or more processors, at least one processor being supplied with said electronic image;
a non-transitory computer readable medium or a plurality of non-transitory computer readable media storing executable instructions, which when executed by the one or more processors, cause performance of the following operations:
establish a bounding box around each of a plurality of said receptacles;
calculate an X offset distance for a first of said pins;
calculate a Y offset distance for the first of said pins: and
generate one or more motor control signals sufficient to enable one or more motors to adjust the position of said connector so as better align it for mating with said vehicle charging port.
